(19) United States
(12) Patent Application Publication
(10) Pub. No.: US 2026/0126365 A1
(43) Pub. Date: May 7, 2026

(54) INTELLIGENT SIMULATION APPARATUS FOR MONITORING FLUID-ROCK DISSOLUTION OF CARBONATE ROCKS USING TEMPERATURE CONTROLLER

(71) Applicant: Chengdu University of Technology, Chengdu (CN)

(72) Inventors: Huaguo WEN, Chengdu (CN); Jintong LIANG, Chengdu (CN); Fei HUO, Chengdu (CN); Yuhan HUANG, Chengdu (CN); Wenli XU, Chengdu (CN); Yuntao LIAO, Chengdu (CN)

(21) Appl. No.: 19/435,689

(22) Filed: Dec. 29, 2025

(30) Foreign Application Priority Data
Jan. 3, 2025 (CN) 202510010282.1

(51) Int. Cl. G01N 15/08; E21B 21/08

(52) U.S. Cl. CPC G01N 15/082; E21B 21/08

(57) ABSTRACT

An intelligent simulation apparatus for monitoring fluid-rock dissolution of carbonate rocks using a temperature controller is provided, including a reactor internally provided with a thermal insulation layer and a working chamber. A front side surface of the reactor is provided with a temperature controller. The working chamber is internally provided with an L-shaped liquid-gas accommodating chamber, a first reaction chamber, a heating chamber and a second reaction chamber. The L-shaped liquid-gas accommodating chamber is internally provided with a temperature sensor and a pressure sensor, which are electrically connected to the temperature controller. The heating chamber is internally provided with a heating wire. Two sides of each of the first reaction chamber and the second reaction chamber are slidably provided with a core holder for holding carbonate rock samples.

### CROSS-REFERENCE TO RELATED APPLICATIONS

This application claims the benefit of priority from Chinese Patent Application No. 202510010282.1, filed on Jan. 3, 2025. The content of the aforementioned application, including any intervening amendments made thereto, is incorporated herein by reference in its entirety.

### TECHNICAL FIELD

This application relates to dissolution simulation experiments, and more particularly to an intelligent simulation apparatus for monitoring fluid-rock dissolution of carbonate rocks using a temperature controller.

### BACKGROUND

Dolostone is a key target in deep oil and gas exploration. Ancient dolostone strata in China have commonly undergone deep burial under high-temperature and high-pressure conditions and long-term superimposed diagenetic modification, during which multiple dissolution processes formed secondary pores and cavities, making them important oil and gas reservoir spaces. Oil and gas production practices further indicate that the degree of development of dissolution pores and cavities is one of the critical factors controlling hydrocarbon productivity. Therefore, elucidating the formation mechanisms and evolutionary processes of dissolution pores and cavities is of vital importance for predicting the distribution of high-quality dolostone reservoirs.

The formation of dissolution pores and cavities involves two mechanisms. One mechanism is dissolution by meteoric water during the early diagenetic stage or an epidiagenetic stage, and the other mechanism is burial dissolution. Burial dissolution is characterized by its particularity, in that dissolution pores or cavities represent end products, and there are no corresponding diagenetic products that can be directly used to analyze the conditions under which the dissolution occurred. As a result, the formation mechanism of burial dissolution has long been a subject of controversy. Dissolution simulation experiments provide an effective research approach for investigating the conditions under which dissolution occurs and the dissolution processes themselves.

Since the 1960s, scholars at home and abroad have conducted experimental studies to explore the dissolution mechanisms of carbonate rocks. With the discovery of numerous deeply buried carbonate oil and gas reservoirs, research on the dissolution mechanisms of carbonate rocks under high-temperature and high-pressure conditions has become a central focus of simulation experiments. Experimental conditions have accordingly evolved from low-temperature and low-pressure to high-temperature and high-pressure environments, and experimental samples used have gradually shifted from single-mineral samples such as calcite and dolomite to actual carbonate rock samples. These studies have contributed to a deeper geological understanding of dolostone dissolution responses under deep burial conditions. However, the controlling effect of dolomite crystal characteristics on dissolution processes and the formation mechanisms of dissolution pores and cavities remain unclear and require further investigation.

### SUMMARY

An object of the disclosure is to provide an intelligent simulation apparatus for monitoring fluid-rock dissolution of carbonate rocks using a temperature controller, where grain-dominated dolostone extensively developed at depth is selected for high-temperature and high-pressure dissolution simulation experiments using an intelligent reactor, thereby investigating the formation and evolution processes of dolostone pores and clarifying dissolution amounts and effects under different diagenetic environments.

Technical solutions of the present disclosure are described as follows.

An intelligent simulation apparatus for monitoring fluid-rock dissolution of carbonate rocks using a temperature controller, comprising:
a reactor;
wherein the reactor has a box-shaped structure; a top surface of the reactor is provided with a main feed inlet; a left side surface of the reactor is provided with an auxiliary feed inlet; and a front side surface of the reactor is provided with a window, a temperature controller and a heating button;
the reactor is internally provided with a thermal insulation layer and a working chamber; the working chamber is internally provided with an L-shaped liquid-gas accommodating chamber, a first reaction chamber, a heating chamber, and a second reaction chamber; the L-shaped liquid-gas accommodating chamber is internally provided with a temperature sensor and a pressure sensor; and the temperature sensor and the pressure sensor are electrically connected to the temperature controller;
the first reaction chamber and the second reaction chamber are provided on two sides of the heating chamber, respectively; the heating chamber is internally provided with a heating wire; and the heating wire is electrically connected to the heating button;
two sides of the first reaction chamber are each slidably provided with a first core holder for holding a first carbonate rock sample; and two sides of the second reaction chamber are each slidably provided with a second core holder for holding a second carbonate rock sample;
right side surfaces of the first reaction chamber and the second reaction chamber are each provided with a return port;
a bottom of the L-shaped liquid-gas accommodating chamber is provided with a first outlet, a second outlet and a third outlet; the first outlet is connected to a differential pressure sensor through a first pipeline to enable real-time and continuous measurement of liquid permeabilities of the first carbonate rock sample and the second carbonate rock sample during a fluid-rock reaction process; the differential pressure sensor has a range of 0.1-10000×10⁻³ μm²;
the second outlet is connected to a sampler through a second pipeline; and
the third outlet is connected to the return port through a third pipeline, a back-pressure pump and a fourth pipeline.

In some embodiments, the first core holder and the second reaction chamber each comprise a hydraulic rod and a piston connected to the hydraulic rod; and a cross-sectional dimension of the piston is the same as a cross-sectional dimension of each of the first reaction chamber and the second reaction chamber.

In some embodiments, the differential pressure sensor is electrically connected to the temperature controller; and the temperature controller is configured to display a measurement value of the differential pressure sensor in real time.

In some embodiments, the back-pressure pump is a plunger pump configured to drive fluid flow within the L-shaped liquid-gas accommodating chamber, so as to achieve fluid circulation.

In some embodiments, the intelligent simulation apparatus further comprising:
a fluid container;
a dual-plunger pump;
a pressure vessel; and
a gas cylinder;
wherein the fluid container is connected to the dual-plunger pump through a fifth pipeline; the dual-plunger pump is connected to the pressure vessel through a sixth pipeline; the gas cylinder is connected to the pressure vessel through a seventh pipeline; and the pressure vessel is connected to the main feed inlet through an eighth pipeline.

In some embodiments, the first pipeline, the second pipeline, the third pipeline, the fourth pipeline, the fifth pipeline, the sixth pipeline, the seventh pipeline and the eighth pipeline are each provided with a valve.

In some embodiments, the fluid container is filled with a fluid; a medium of the fluid is acetic acid from oilfield water at a concentration of 2 g/L, 4 g/L, 5 g/L, 6 g/L or 8 g/L; the fluid further comprises sodium sulfate, calcium chloride and magnesium chloride; and the gas cylinder is filled with carbon dioxide gas.

In some embodiments, the first reaction chamber and second reaction chamber each have a temperature ranging from room temperature to 400° C., and a pressure ranging from atmospheric pressure to 100 Mpa; and a fluid flow rate inside the first reaction chamber and second reaction chamber is 0.1-10 mL/s.

Compared to the prior art, the present disclosure has the following beneficial effects.

(1) The present disclosure combines high-precision detection technologies including a temperature controller, a temperature sensor, a pressure sensor and a differential pressure sensor, thereby improving the testing quality of the reactor and enabling carbonate rock fluid-rock dissolution simulation experiments to deliver more accurate and reliable results under various environmental conditions, while reducing testing time.

(2) By simulating high-temperature, high-pressure and high-salinity fluids, quantitative simulation of dissolution in carbonate strata during continuous deep burial under near-geological conditions is achieved, so as to analyze pore-forming peak stages favorable for the occurrence of burial dissolution in carbonate rocks.

(3) By conducting internal rock dissolution experiments, burial dissolution of carbonate rocks with different pore types is simulated. By measuring porosity and permeability values of the test samples before and after dissolution, the evolution of internal pore structures, and real-time changes in fluid permeability during the dissolution process, the evolution pathways of burial dissolution pores in carbonate rocks and a quantitative assessment of dissolution effects can be determined.

### BRIEF DESCRIPTION OF THE DRAWINGS

In order to illustrate the technical solutions in the embodiments of the present disclosure or the prior art more clearly, the accompanying drawings needed in the description of the embodiments or prior art will be briefly described below. Obviously, presented in the accompanying drawings are only some embodiments of the present disclosure, and for those of ordinary skill in the art, other accompanying drawings can be obtained from the structures illustrated therein without making creative effort.

FIG. 1 is an external view of a reactor of an intelligent simulation apparatus for monitoring fluid-rock dissolution of carbonate rocks using a temperature controller according to an embodiment of the present disclosure;

FIG. 2 is an internal view of the reactor of the intelligent simulation apparatus for monitoring fluid-rock dissolution of carbonate rocks using a temperature controller according to an embodiment of the present disclosure; and

FIG. 3 schematically shows the intelligent simulation apparatus for monitoring fluid-rock dissolution of carbonate rocks using a temperature controller according to an embodiment of the present disclosure.

### DETAILED DESCRIPTION OF EMBODIMENTS

The technical solutions in the embodiments of the present disclosure will be described clearly and completely below in conjunction with the accompanying drawings. It is obvious that the described embodiments are merely some embodiments of the present disclosure, instead of all embodiments. Based on the embodiments in the present disclosure, all other embodiments obtained by those of ordinary skill in the art without making creative effort shall fall within the scope of the present disclosure defined by the appended claims.

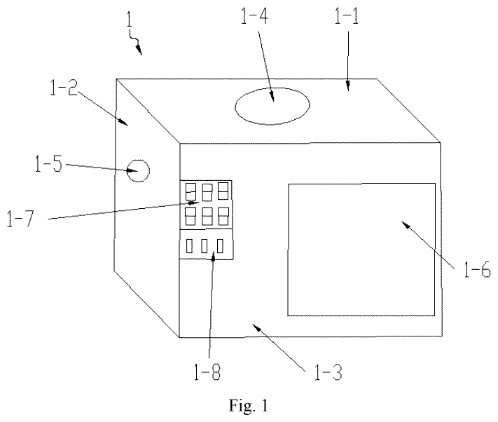

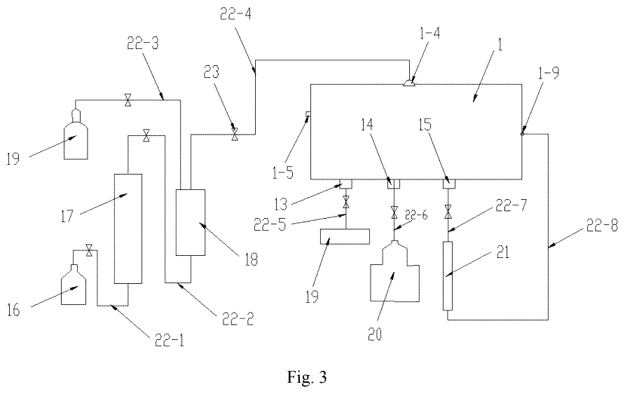

As shown in FIGS. 1, 2 and 3, an embodiment of the present disclosure provides an intelligent simulation apparatus for monitoring fluid-rock dissolution of carbonate rocks using a temperature controller, including a reactor 1 having a box-shaped structure. A top surface 1-1 of the reactor 1 is provided with a main feed inlet 1-4. A left side surface 1-2 of the reactor 1 is provided with an auxiliary feed inlet 1-5. A front side surface of the reactor 1 is provided with a window 1-6, a temperature controller 1-7 and a heating button 1-8.

The reactor 1 is internally provided with a thermal insulation layer 2 and a working chamber. The working chamber is internally provided with an L-shaped liquid-gas accommodating chamber 3, a first reaction chamber 4, a heating chamber 5 and a second reaction chamber 6. The L-shaped liquid-gas accommodating chamber 3 is internally provided with a temperature sensor 11 and a pressure sensor 12. The temperature sensor 11 and the pressure sensor 12 are electrically connected to the temperature controller 1-7. The first reaction chamber 4 and the second reaction chamber 6 are arranged on two sides of the heating chamber 5, respectively. The heating chamber 5 is internally provided with a heating wire 5-1. The heating wire 5-1 is electrically connected to the heating button 1-8. The temperature controller 1-7 is configured to set a preset upper threshold for a current test temperature. When the preset temperature is reached, the heating button 1-8 is controlled to stop heating. The temperature controller 1-7 also displays a current temperature and a preset upper temperature limit in real time.

Two sides of the first reaction chamber 4 are each slidably provided with a first core holder 7 for holding a first carbonate rock sample 4-1. Two sides of the second reaction chamber 6 are each slidably provided with a second core holder 8 for holding a second carbonate rock sample 6-1. Right side surfaces of the first reaction chamber 4 and the second reaction chamber 6 are each provided with a return port 1-9.

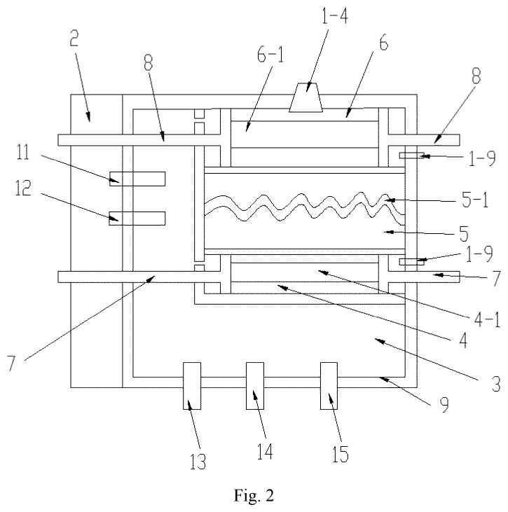

The L-shaped liquid-gas accommodating chamber 3 is surrounded by a high-temperature and high-pressure resistant rubber layer 9. A bottom of the L-shaped liquid-gas accommodating chamber 3 is provided with a first outlet 13, a second outlet 14 and a third outlet 15. The first outlet 13 is connected to a differential pressure sensor 19 through a first pipeline 22-5 to enable real-time and continuous measurement of fluid permeabilities of the first carbonate rock sample 4-1 and the second carbonate rock sample 6-1 during a fluid-rock reaction process. The differential pressure sensor 19 has a measurement range of 0.1-10000×10⁻³ μm². The second outlet 14 is connected to a sampler 20 through a second pipeline 22-6. The third outlet 15 is connected to the return port 1-9 through a third pipeline 22-7, a back-pressure pump 21 and a fourth pipeline 22-8. The back-pressure pump 21 is a high-precision, high-pressure plunger pump configured to drive fluid flow within the L-shaped liquid-gas accommodating chamber 3, so as to achieve fluid circulation under high-temperature and high-pressure conditions. FIG. 2 is a partial cross-sectional view of the reactor 1, showing that the main feed inlet 1-4 is communicated with the L-shaped liquid-gas accommodating chamber 3.

In this embodiment, an ion concentration in a solution generated during the dissolution and collected by the sampler 20 is measured, a connected pore volume, gas porosity, gas permeability, and mass of the carbonate rock sample after dissolution are determined. Changes in gas porosity, gas permeability, and mass before and after dissolution are calculated, thereby enabling quantitative assessment of the dissolution amount and dissolution effects of carbonate rocks under different diagenetic conditions.

The first core holder 7 and the second reaction chamber 6 each include a hydraulic rod and a piston connected to the hydraulic rod. A cross-sectional dimension of the piston is the same as a cross-sectional dimension of each of the first reaction chamber 4 and the second reaction chamber 6. The differential pressure sensor 19 is electrically connected to the temperature controller 1-7. The temperature controller 1-7 is configured to display a measurement value of the differential pressure sensor 19 in real time.

The intelligent simulation apparatus further includes a fluid container 16, a dual-plunger pump 17, a pressure vessel 18 and a gas cylinder 19. The fluid container 16 is connected to the dual-plunger pump 17 through a fifth pipeline 22-1. The dual-plunger pump 17 is connected to the pressure vessel 18 through a sixth pipeline 22-2. The gas cylinder 19 is connected to the pressure vessel 18 through a seventh pipeline 22-3. The pressure vessel 18 is connected to the main feed inlet 1-4 through an eighth pipeline 22-4. In this embodiment, the first pipeline 22-5, the second pipeline 22-6, the third pipeline 22-7, the fourth pipeline 22-8, the fifth pipeline 22-1, the sixth pipeline 22-2, the seventh pipeline 22-3 and the eighth pipeline 22-4 are each provided with a valve 23.

The fluid container 16 is filled with a fluid. A medium of the fluid is acetic acid from oilfield water at a concentration of 2 g/L, 4 g/L, 5 g/L, 6 g/L or 8 g/L. The fluid further includes sodium sulfate, calcium chloride and magnesium chloride. The gas cylinder 19 is filled with carbon dioxide gas. The first reaction chamber 4 and the second reaction chamber 6 each have a temperature ranging from room temperature to 400° C., and a pressure ranging from atmospheric pressure to 100 MPa. A fluid flow rate inside the first reaction chamber 4 and second reaction chamber 6 is 0.1-10 mL/s. The first carbonate rock sample 4-1 and the second carbonate rock sample 6-1 are selected from extensively developed grain-dominated dolostone, and high-temperature and high-pressure dissolution simulation experiments are conducted on the carbonate rock samples to investigate formation and evolution processes of dolostone pores and to clarify dissolution amounts and dissolution effects under different diagenetic environments.

The present disclosure further provides an intelligent simulation experimental method for monitoring fluid-rock dissolution of carbonate rocks using a temperature controller, which is implemented by the intelligent simulation apparatus described above. The method includes the following steps.

Step (S1) A fluid is placed in a fluid container, and carbon dioxide gas is introduced into a gas cylinder. Under preset temperature, pressure and flow rate conditions, the fluid is injected into a reactor containing carbonate rock samples, such that a fluid-rock reaction is carried out between the fluid and the carbonate rock samples.

Step (S2) An ion concentration in a solution generated during the dissolution and collected by a sampler is measured, and a connected pore volume, gas porosity, gas permeability, and mass of the carbonate rock samples after dissolution are determined. Changes in gas porosity, gas permeability, and mass before and after dissolution are calculated, thereby enabling a quantitative evaluation of dissolution amount and dissolution effects of the carbonate rocks under different diagenetic environments.

In some embodiments, in step S1, a medium of the fluid is acetic acid from oilfield water at a concentration of 2 g/L, 4 g/L, 5 g/L, 6 g/L or 8 g/L. In step S1, the fluid further includes sodium sulfate, calcium chloride and magnesium chloride. In step S1, the carbonate rock samples are calcareous dolostones from the Lower Cambrian Longwangmiao Formation in the Sichuan Basin, with a calcite content of 49.7% and a dolomite content of 49.2%. In step S1, the first reaction chamber and the second reaction chamber each have a temperature ranging from room temperature to 400° C. and a pressure ranging from atmospheric pressure to 100 MPa. A fluid flow rate inside the first reaction chamber and the second reaction chamber is 0.1 to 10 mL/s.

In step S2, two portions of the solution generated during dissolution, each with a volume of 6 mL, are collected for the determination of Ca 2+and Mg 2+ion concentrations, so as to analyze the dissolution rate of the rock. The carbonate rock samples in step S2 are subjected to porosity and permeability measurements as well as computed tomography (CT) scanning to examine the characteristics of pore structure changes.

The embodiments described above are merely preferred embodiments of the present disclosure, and are not intended to limit the scope of the present disclosure. It should be understood that various modifications, changes and replacements made by those skilled in the art without departing from the spirit of the disclosure shall fall within the scope of the present disclosure defined by the appended claims.

What is claimed is:

1. An intelligent simulation apparatus for monitoring fluid-rock dissolution of carbonate rocks using a temperature controller, comprising:
a reactor;
wherein the reactor has a box-shaped structure; a top surface of the reactor is provided with a main feed inlet; a left side surface of the reactor is provided with an auxiliary feed inlet; and a front side surface of the reactor is provided with a window, a temperature controller and a heating button;
the reactor is internally provided with a thermal insulation layer and a working chamber; the working chamber is internally provided with an L-shaped liquid-gas accommodating chamber, a first reaction chamber, a heating chamber and a second reaction chamber; the L-shaped liquid-gas accommodating chamber is internally provided with a temperature sensor and a pressure sensor; and the temperature sensor and the pressure sensor are electrically connected to the temperature controller;
the first reaction chamber and the second reaction chamber are provided on two sides of the heating chamber, respectively; the heating chamber is internally provided with a heating wire; and the heating wire is electrically connected to the heating button;
two sides of the first reaction chamber are each slidably provided with a first core holder for holding a first carbonate rock sample; and two sides of the second reaction chamber are each slidably provided with a second core holder for holding a second carbonate rock sample;
right side surfaces of the first reaction chamber and the second reaction chamber are each provided with a return port;
a bottom of the L-shaped liquid-gas accommodating chamber is provided with a first outlet, a second outlet and a third outlet; the first outlet is connected to a differential pressure sensor through a first pipeline to enable real-time and continuous measurement of liquid permeabilities of the first carbonate rock sample and the second carbonate rock sample during a fluid-rock reaction process; the differential pressure sensor has a measurement range of 0.1-10,000×10⁻³ μm²;
the second outlet is connected to a sampler through a second pipeline; and
the third outlet is connected to the return port through a third pipeline, a back-pressure pump and a fourth pipeline.

2. The intelligent simulation apparatus of claim 1, wherein the first core holder and the second reaction chamber each comprise a hydraulic rod and a piston connected to the hydraulic rod; and a cross-sectional dimension of the piston is the same as a cross-sectional dimension of each of the first reaction chamber and the second reaction chamber.

3. The intelligent simulation apparatus of claim 1, wherein the differential pressure sensor is electrically connected to the temperature controller; and the temperature controller is configured to display a measurement value of the differential pressure sensor in real time.

4. The intelligent simulation apparatus of claim 1, wherein the back-pressure pump is a plunger pump configured to drive fluid flow within the L-shaped liquid-gas accommodating chamber, so as to achieve fluid circulation.

5. The intelligent simulation apparatus of claim 1, further comprising:
a fluid container;
a dual-plunger pump;
a pressure vessel; and
a gas cylinder;
wherein the fluid container is connected to the dual-plunger pump through a fifth pipeline; the dual-plunger pump is connected to the pressure vessel through a sixth pipeline; the gas cylinder is connected to the pressure vessel through a seventh pipeline; and the pressure vessel is connected to the main feed inlet through an eighth pipeline.

6. The intelligent simulation apparatus of claim 5, wherein the first pipeline, the second pipeline, the third pipeline, the fourth pipeline, the fifth pipeline, the sixth pipeline, the seventh pipeline and the eighth pipeline are each provided with a valve.

7. The intelligent simulation apparatus of claim 5, wherein the fluid container is filled with a fluid; a medium of the fluid is acetic acid from oilfield water at a concentration of 2 g/L, 4 g/L, 5 g/L, 6 g/L or 8 g/L; the fluid further comprises sodium sulfate, calcium chloride and magnesium chloride; and the gas cylinder is filled with carbon dioxide gas.

8. The intelligent simulation apparatus of claim 1, wherein the first reaction chamber and second reaction chamber each have a temperature ranging from room temperature to 400° C., and a pressure ranging from atmospheric pressure to 100 MPa; and a fluid flow rate inside the first reaction chamber and second reaction chamber is 0.1-10 mL/s.
